(19) United States
(12) Patent Application Publication
(10) Pub. No.: US 2012/0145693 A1
(43) Pub. Date: Jun. 14, 2012

(54) HYBRID HEATING APPARATUS

(76) Inventor: David Deng, Diamond Bar, CA (US)

(21) Appl. No.: 13/310,649

(22) Filed: Dec. 2, 2011

Related U.S. Application Data
(60) Provisional application No. 61/515,060, filed on Aug. 4, 2011.

(30) Foreign Application Priority Data
Dec. 13, 2010 (CN) 201020661219.3

(51) Int. Cl. H05B 1/00

(52) U.S. Cl. 219/201

(57) ABSTRACT

A heating apparatus can be a dual heating power source or a hybrid heater. For example, the heating apparatus can include a fuel delivery system for combusting a gas fuel and a separate electronic heater. Other types of heating sources or methods can also be used to provide the heating apparatus with more than one heating source and/or heating method. The heating apparatus can also include one or more air flow channel to facilitate efficient heating of air flow through the heating apparatus.

### CROSS-REFERENCE TO RELATED APPLICATIONS

This application claims priority to U.S. Provisional Application No. 61/515060, filed Aug. 4, 2011 and to Chinese Patent Application No. 201020661219.3, filed Dec. 13, 2010 which are incorporated by reference herein in their entirety.

### BACKGROUND OF THE INVENTION

1. Field of the Invention

Certain embodiments disclosed herein relate generally to a hybrid heating apparatus. The hybrid heating apparatus can use one or more energy or fuel sources to provide the desired heating. The hybrid heating apparatus can be, can be a part of, and can be used in or with many different appliances, including, but not limited to: heaters, boilers, dryers, washing machines, ovens, fireplaces, stoves, water heaters, etc.

2. Description of the Related Art

There exists a constant need for improvement in appliances and components to be used in appliances.

### SUMMARY OF THE INVENTION

A heating system can include a housing, a gas heating unit positioned within the housing, and an electric heating element positioned within the housing.

According to some embodiments a heating system can include any number of different components such as a fuel selector valve, a pressure regulator, a control valve, a burner nozzle, a burner, and/or an oxygen depletion sensor. In addition, a heating system can be a single fuel, dual fuel or multi-fuel heating system. For example, the heating system can be configured to be used with one or more of natural gas, liquid propane, well gas, city gas, and methane. The heating system can take many different forms including at least one of a vent free heater, a direct vent heater, a plaque heater, a stove, a blue flame generating heater, a yellow flame generating heater, and a dual-fuel heater.

A heating apparatus can comprise a housing having at least one air inlet, at least one air outlet and a firebox. The heating apparatus can also include a gas heating unit, an electric heating element, and a feedback system configured to monitor a temperature and control the utilization of both the gas heating unit and the electric heating element to provide desired heating. In some embodiments, the gas heating unit can comprise a pressure regulator configured to regulate a flow of fuel, a burner positioned within the firebox and configured such that combustion occurs within the firebox, a nozzle configured to direct the flow of fuel to the burner, and a control valve positioned in fluid communication with and between the pressure regulator and the nozzle and configured to control the amount of fuel in the flow of fuel.

In some embodiments, a heating apparatus can comprise a housing with a firebox and an air channel outside of and surrounding at least part of the firebox. The heating apparatus can also include a gas heating unit positioned within the housing, an electric heating element positioned within the air channel and configured such that air within the air channel is heated by heat from the electric heating element; and a thermostat configured to control both the gas heating unit and the electric heating element.

The gas unit of some embodiments can comprise a pressure regulator configured to regulate a flow of fuel, a burner positioned within the firebox and configured such that combustion occurs within the firebox, and a nozzle configured to direct the flow of fuel to the burner.

According to some embodiments, a heating apparatus can comprise a housing having at least one air inlet, at least one air outlet, a firebox, and an air channel outside of and surrounding at least part of the firebox. The heating apparatus can also include a gas heating unit positioned within the housing and a plurality of electric heating elements positioned within the air channel and configured such that air within the air channel is heated by heat from the plurality of electric heating elements. The gas unit may include one or more of a pressure regulator configured to regulate a flow of fuel, a burner positioned within the firebox and configured such that combustion occurs within the firebox, and a nozzle configured to direct the flow of fuel to the burner.

A hybrid heater control method can comprise at least one of the following steps. Providing heat with an electric heating element. Sensing a decrease in temperature from a setpoint temperature. Activating a gas heating unit to combust gas at a burner. Providing heat with both the gas heating unit and the electric heating element. Sensing a return in temperature to the setpoint temperature. Deactivating the gas heating unit. Continuing to provide heat with the electric heating element.

In some embodiments, activating the gas heating unit can comprise igniting a first gas flow at a pilot light or oxygen depletion sensor. In some embodiments, activating the gas heating unit can further comprise igniting a second gas flow at the burner.

A heating apparatus can include a housing, a gas heating unit positioned within the housing, and an electric heating element positioned within the housing. The housing can have at least one air inlet, at least one air outlet, and a firebox. The gas heating unit can include a pressure regulator configured to regulate a flow of fuel, a burner configured such that combustion occurs within the firebox, a nozzle positioned to direct the flow of fuel to the burner; and a control valve configured to control the amount of fuel in the flow of fuel.

In some embodiments, the heating apparatus can comprise a first air channel outside of and surrounding at least part of the firebox. The first air channel can be configured such that air within the first air channel is heated by heat from the firebox. A second air channel can be configured such that air within the second air channel is heated by heat from the electric heating element. The heating apparatus may also include a fan positioned within the housing configured to draw air into the housing through the at least one air inlet.

A heating apparatus can comprise a housing having at least one air inlet, at least one air outlet, a firebox, a first air channel outside of and surrounding at least part of the firebox, and a second air channel. The heating apparatus may also include a gas heating unit positioned within the housing and having a pressure regulator configured to regulate a flow of fuel, a burner positioned within the firebox and configured such that combustion occurs within the firebox, a nozzle configured to direct the flow of fuel to the burner, and a control valve positioned in fluid communication with and between the pressure regulator and the nozzle and configured to control the amount of fuel in the flow of fuel. In some embodiments, an electric heating element can be positioned within the second air channel and configured such that air within the second air channel is heated by heat from the electric heating element.

### BRIEF DESCRIPTION OF THE DRAWINGS

Various embodiments are depicted in the accompanying drawings for illustrative purposes, and should in no way be interpreted as limiting the scope of the inventions, in which like reference characters denote corresponding features consistently throughout similar embodiments.

FIG. 1 is a perspective view of a heater.

FIG. 2 is a perspective cutaway view of a heater.

FIG. 3 shows a schematic cross-section of the heater of FIG. 1.

FIG. 4 illustrates a schematic cross-section of another heater.

FIG. 5 is a perspective cross sectional view of another heater.

FIG. 6 is a cross sectional schematic view of the heater of FIG. 5.

FIG. 7 shows a cross sectional schematic view of the heater of FIG. 5.

### DETAILED DESCRIPTION OF THE PREFERRED EMBODIMENT

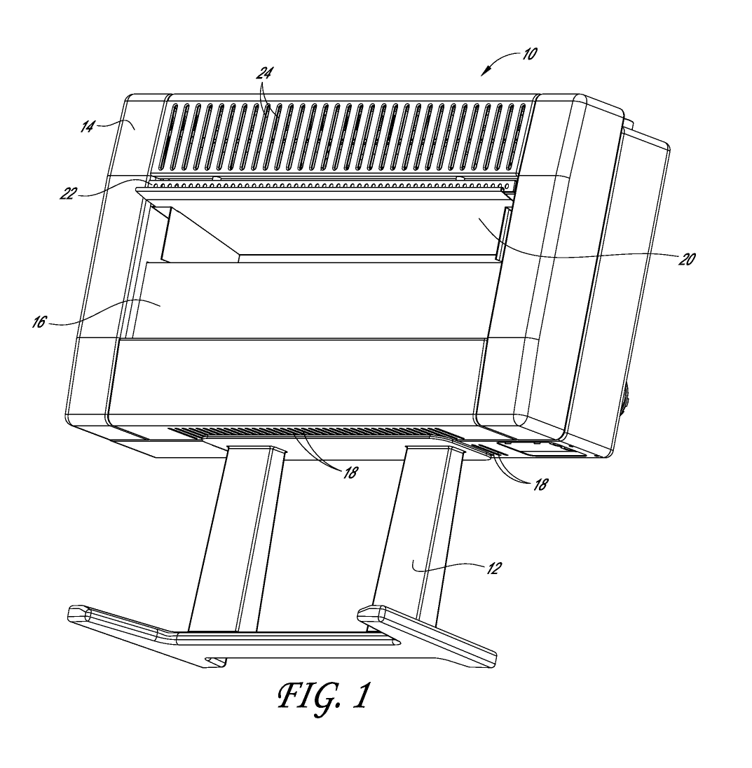

FIG. 1 illustrates an embodiment of a heater 10. It should be understood that the illustrated heater includes each of the features designated by the numbers used herein. However, as emphasized repeatedly herein, these features need not be present in all embodiments. In various embodiments, the heater is a vent-free infrared heater, a vent-free blue flame heater, or some other variety of heater, such as a direct vent heater. In some embodiments, the heater can comprise any suitable fluid-fuel burning unit, such as, for example, a fireplace, fireplace insert, heating stove, cooking stove, barbecue grill, or water heater. Other configurations are also possible for the heater. In many embodiments, the heater is configured to be mounted to a wall or a floor or to otherwise rest in a substantially static position. In other embodiments, the heater is configured to move within a limited range. In still other embodiments, the heater is portable.

The heater 10 can be a hybrid heater that can utilize two or more different energy sources and/or methods to provide the desired heating. For example, the heater 10 can include a gas-type fuel delivery system 11 and one or more electric heating elements 28 as will be described in detail below. It will also be understood that the heater can use either a fuel delivery system or a heating element together with other heating methods and/or energy sources such as hot water, heated exhaust, geothermal heating, a heat exchanger, a thermoelectric heat pump, a Peltier heater, etc.

In certain embodiments, the heater 10 comprises a housing 14. The housing 14 can be placed and/or connected to a base 12. The housing 14 can include metal or some other suitable material for providing structure to the heater 10 without melting or otherwise deforming in a heated environment. In some embodiments, the housing 14 comprises a window 16 through which heated air and/or radiant energy can pass. In further embodiments, the housing 14 comprises one or more intake vents 18 through which air can flow into the heater 10. In some embodiments, the housing 14 comprises outlet openings and/or vents 20, 22, 24 through which heated air can flow out of the heater 10.

Within the housing 14, the heater 10, or other gas appliance, can include a fuel delivery system 11. A fuel delivery system can include at least one or more of the components described herein. As shown and as will be described below, the heater can be a dual fuel heater configured to use one among two different types of fuels. It will be understood that the heater can also be a heater designed to run on only a single fuel.

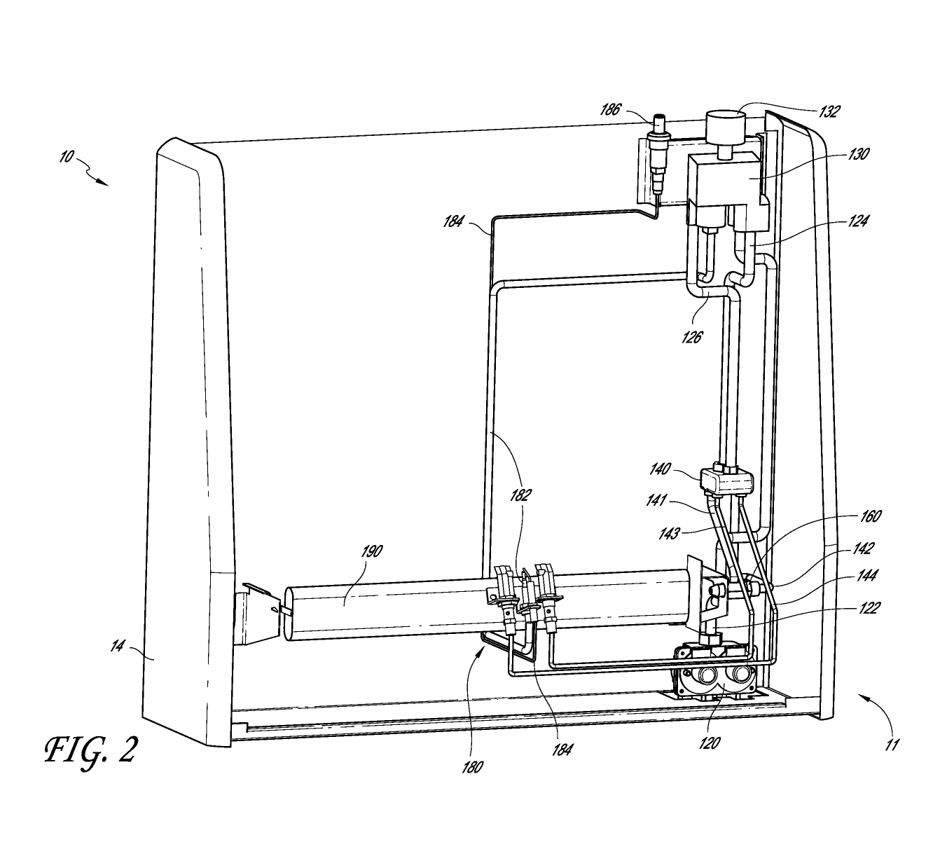

With reference to FIG. 2, an example of a fuel delivery system 11 is shown. The fuel delivery system 11 can include a regulator 120. The regulator 120 can be configured to selectively receive a fluid fuel (e.g., propane or natural gas) from a source at a certain pressure. For example, a propone tank can be connected to the regulator 120 to provide fuel to the heater. In certain embodiments, the regulator 120 includes one or more input ports for receiving the fuel. The regulator 120 can define an output port through which fuel exits the regulator 120. In certain embodiments, the regulator 120 is configured to regulate fuel entering the input port such that fuel exiting the output port is at a relatively steady pressure. The regulator 120 can function in ways similar to the pressure regulators disclosed in U.S. Pat. No. 7,434,447, filed on May 30, 2006, and incorporated by reference herein,

The output port of the regulator 120 can be coupled with a source line or channel 122. The source line 122, and any other fluid line described herein, can comprise piping, tubing, conduit, or any other suitable structure adapted to direct or channel fuel along a flow path. In some embodiments, the source line 122 is coupled with the output port at one end and is coupled with a control valve 130 at another end. The source line 122 can thus provide fluid communication between the regulator 120 and the control valve 130.

The control valve 130 can be configured to regulate the amount of fuel delivered to portions of the fuel delivery system 11. Various configurations of the control valve 11 are possible, including those known in the art as well as those yet to be devised. In some embodiments, the control valve 130 includes a millivolt valve. The control valve 130 can include one or more knobs or dials 132. In some embodiments, the dial 132 can be rotated to adjust the amount of fuel delivered to a burner and/or to adjust a setting of a thermostat.

In many embodiments, the control valve 130 is coupled with a burner transport line or channel 124 which is connected to a nozzle assembly 160. The nozzle assembly 160 can be configured to direct fuel received from the control valve 130 to the burner 190 where the fuel can be combusted. The burner 135 can comprise any suitable burner, such as, for example, a ceramic tile burner or a blue flame burner, and is preferably configured to continuously combust fuel.

In some embodiments, the control valve 130 is also coupled with a pilot transport line or an oxygen depletion sensor delivery line 126 to deliver fuel to a pilot light or to an oxygen depletion sensor (ODS) 180. Fuel delivered to the ODS 180 can be combusted to form a flame, which can serve to ignite fuel delivered to the burner 135 and/or serve as a safety control feedback mechanism that can cause the control valve 130 to shut off delivery of fuel to the fuel delivery system 11. In some embodiments, the ODS comprises a thermocouple 182, which can be coupled with the control valve 130, and an igniter line 184, which can be coupled with an igniter switch 186. Any of the lines 182, 184 can comprise any suitable medium for communicating an electrical quantity, such as a voltage or an electrical current. For example, in some embodiments, one or more of the lines 182, 184 comprise a metal wire.

Additionally, the burner transport line 124 and pilot or ODS transport line 126 can be connected to a fluid flow controller 140 which can then further control the flow of fluid to the nozzle assembly 160 and oxygen depletion sensor 180. For example, where the heater 10 is a dual fuel heater, the fluid flow controller 140 can control which of various flow paths the fuel will travel to arrive at the nozzle assembly 160 and the ODS 180. Thus two channels 141, 142 can connect the fluid flow controller 140 with the nozzle assembly 160 and two channels 143, 144 can connect the fluid flow controller 140 and the ODS 180. The ODS, fluid flow controller, nozzle, and any of the other features can function in ways similar to those disclosed in U.S. Pat. No. 7,434,447, filed on May 30, 2006, and incorporated by reference herein.

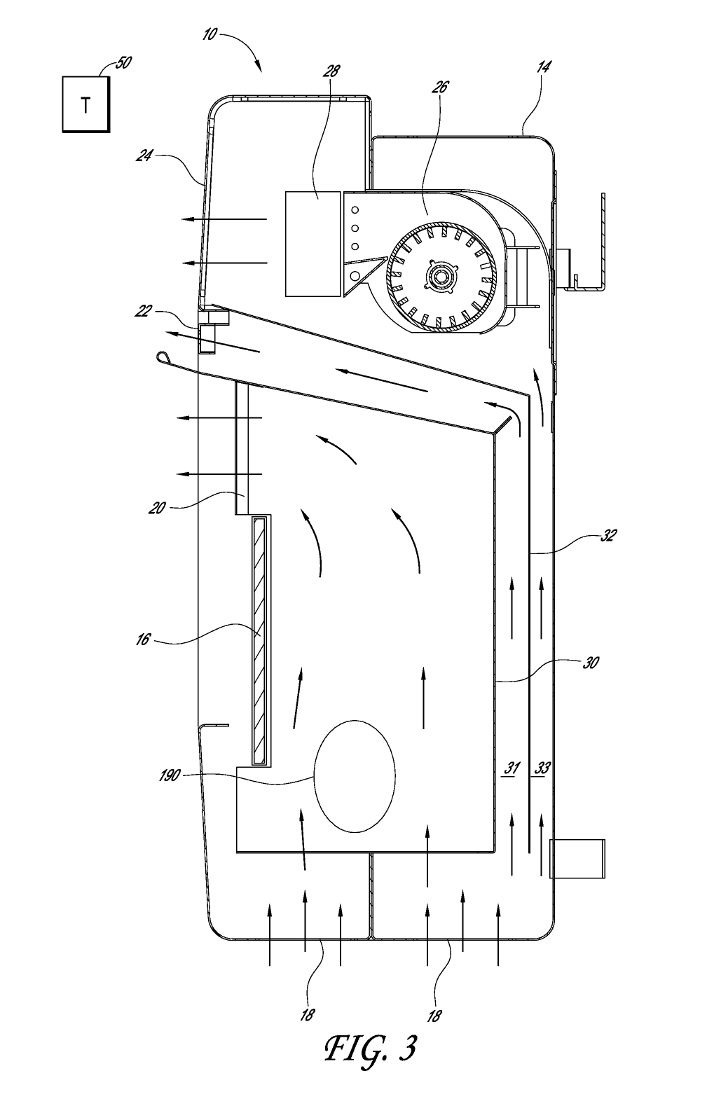

Turning now to FIG. 3, a schematic cross-section of a heater 10 and an example air flow pattern through the heater 10 is shown. The heater 10 can be the same or similar to those described above and can include a fuel delivery system 11. For clarity, the fuel delivery system 11 has been removed with the exception of the burner 190.

FIG. 3 illustrates a heater 10 that in addition to a fuel delivery system 11 also includes an electronic heater and/or electronic heating element 28. The gas and electric hybrid heater 10 can heat the air through one or more methods. For example, combustion of gas at the burner can be used to heat the air, or the heated exhaust can be used. Additionally, or independently, the electric heating element can also heat the air. As an example, the electric heating element 28 can be used when the heater is turned on to provide quick initial heating as the fuel delivery system heats up. Thereafter, one or both of the electric heating element and the fuel delivery system can provide the desired heat. As another example, both the electric heating element and the fuel delivery system can provide initial heat to raise the temperature of a room to the desired temperature. Thereafter, the electric heating element can be used to maintain the temperature and the fuel delivery system can kick in when needed for extra heating.

Many different types of heating elements 28 can be used. The heating element can be made of metal or ceramic, such as a Positive Thermal Coefficient of resistance ceramic, it can be a heat lamp, an incandescent lamp, an infrared emitter or heater, a quartz emitter, ceramic infrared, etc. The heating element can be made from nichrome, a nickel and chromium alloy. The heating element can be made of nichrome wire wrapped around a mica sheet. Other types of heating elements can also be used.

The heater 10 can also include one or more fans 26. The one or more fans can be used to direct airflow through certain regions of the heater 10. The one or more fans 26 can be used to direct airflow through the heater 10, such as through the housing 14 and/or the firebox 30. In particular, the one or more fans 26 can direct air in and around the heating elements, the area of combustion, heated surfaces, etc. to increase the temperature of the air (forced convection) and direct the increased temperature air into the room environment.

As shown, the electric heating element 28 is directly adjacent the fan's airflow exit nozzle. Thus, the fan 26 can direct air through and/or around the heating element 28 to heat the air and to provide a heated flow of air out the outlet 24. A heater 10 can use one or more heating elements 28 that can be positioned directly adjacent the fan, near the fan, within an air flow path, etc. The fan 26 can also be used to draw air into the heater 10 such as through the inlet 18. In some embodiments, additional fans may be used. For example, a fan can be placed at or near the inlet 18.

Airflow can take various paths through the heater 10, as indicated by the arrows in FIG. 3. For example, air is shown entering the inlet 18. From there, air can flow to the burner 190. This air can be used for combustion. The heated exhaust air can then exit through the outlet 20 to the heater's surroundings. The heater 10 includes a window 16 such that airflow is directed over and around the window 16. As can also be seen, the burner 190 is located within a combustion chamber or firebox 30. The firebox 30 contains the combustion process and prevents the flames and/or excessive heat from reaching certain areas within the heater and/or components within the heater. For example, certain components of the fuel delivery system 11 can be located outside of the firebox 30. Generally, those components of the fuel delivery system 11 used for combustion will be located within the firebox 30, namely the burner 190 and, if present, an ODS 180 or a pilot light.

In some embodiments, the heater 10 can also include one or more channels 31, 33 surrounding and/or outside of the firebox 30. Air that is drawn into the inlet 18 may also flow through these channels so that the air can be heated and the heated air can then be expelled or exhausted out one of the outlets. As shown, there are two channels 31, 33 outside of and surrounding the firebox 30. In some embodiments, there may be no channels outside of the firebox or one, two, three, or more channels outside of and surrounding the firebox. These channels may be separate channels or they may be separate along part of their length and may combine with one another at other regions. For example, a single inlet can be used by multiple channels. In addition, two or more channels may extend separately along a portion of the heater and then may combine prior to exiting out the same outlet.

In some embodiments, the heater 10 can have a single channel positioned outside of the firebox 30. Air in the channel can be heated by a heating element and may also be heated by heat transfer through the firebox 30. In normal usage, the firebox can become very hot. The air in the channel can reduce the temperature of the firebox by first transferring some of that heat to the air in the channel Then this heated air can forced out of the heater to transfer some of the heat to the outside environment, such as the room environment. An increased flow of air, such as with a high speed fan, can increase the rate of heat transfer which beneficially cools down the firebox and heats up the room environment.

One or more panels 32 can be used to separate and/or create additional channels within the heater 10. Air can flow through the channels in various ways and for various purposes. In some embodiments, some or all of the panels 32 can be adiabatic panels. In other words, some or all of the panels 32 can insulate a channel from other channels such that the temperature within one channel does not affect the temperature within the other channel An adiabatic boundary is a boundary that is impermeable to heat transfer and the system is said to be adiabatically (or thermally) insulated.

In some embodiments, a first channel 31 may be formed between the firebox 30 and a panel 32. This first channel 31 can be proximate to or in contact with the firebox 30. In this way, heat can be transferred from the firebox to the air within the first channel 31. This heated air can then be exhausted out outlet 22.

A second channel 33 can be formed between the panel 32 and the heater housing 14. Air can flow from the inlet 18 through the second channel 33, being drawn up by the fan 26. The fan 26 can direct air to the electric heating element 28 to be heated and then exhausted out outlet 24. Thus, as illustrated in FIG. 3, the heater 10 can take air from at least one inlet 18 and divide it into separate streams. One stream is heated through combustion at the burner 190, the heated air exiting outlet 20. Another stream flows through the first channel 31 between the firebox and the panel 32. That stream of air extracts heat from the heated firebox and then exits outlet 22. Finally, the second channel 33, positioned between the panel 32 and the housing 14, draws air up through the channel by the fan and heats the air with the heating element 28. This heated air then exits outlet 24.

In some embodiments, a portion of the one or more panels 32 and/or the firebox 30 can be angled. Angling of the panels can be used to direct the flow of air through the heater 10. For example as shown in FIG. 3, a top portion of the firebox 30 and/or panel 32 can be angled. The firebox and/or one or more panels 32, can be angled and/or include an angled baffle. This can assist in maintaining the heated air flowing through the heater and out the outlets with or without a fan.

Though a heater is not shown without a fan, a fan is not required. The heater 10 can be configured in such a way to take advantage of the natural rising of heated air which will occur within the heater 10. For example, the one or more inlets 18 can be located below the one or more outlets 20, 22, 24. As another example, the firebox and/or panels can be angled or inclined, as mentioned above. As cooler or ambient temperature air enters the inlet it can be heated, causing it to rise and eventually leave through the outlet. This can cause a current of air flow within the heater 10 with fresh cooler air entering the inlet and heated air leaving the heater through the outlet.

The hybrid configuration of a gas and electric heater can provide many benefits to a user. The hybrid heater 10 can provide a steady output of heat within a desired temperature range. For example, the gas and electric heater components can provide separate heating capabilities that can provide heat, for example, independent of a power outage or a break in fuel supply. Where the flow of fuel to the burner 190 may, at times, be unsteady and provide a variable amount of heat, the electric heater can be used to supplement the provided heat. Conversely, the electronic heater may be limited in the heat that it can provide because of the power rating of a circuit it is connected to, while the gas fuel can provide a greater amount of heat that is not as limited as the electronic heater. For example, in a typical home set-up, a hybrid heater can provide a greater amount of heat from the combustion of gas than from the electric heater. The fuel delivery system 11 and/or the electronic heater 28 can be turned on on a cyclical, constant or as needed basis.

The heater 10 can also be connected to a control or feedback system 50 that provides feedback to the heater 10. The feedback system 50 can comprise a thermostat or sensor, such as a thermocouple, that can provide temperature feedback to the heater 10. The feedback system 50 can be used to regulate the temperature and to control the two different heat sources. For example, the electric heater 28 can remain on to provide a steady supply of heat. When the feedback system 50 detects a decrease in temperature the fuel delivery system 11 can turn on to provide the extra heat needed. This may occur, for example, after a door to the outside has been opened. Thus, the electric heater and the fuel delivery device 11 can be used with the feedback system to regulate the temperature or maintain a fairly steady temperature, turning on one system only when needed to boost the heat output, provide supplemental heated air, or adjusting heat output in real time to maintain the desired temperature.

The thermostat 50 may be the control system or a component of the control system which regulates the temperature of the heater 10 so that the heater's temperature output is maintained near a desired setpoint temperature. The thermostat can be constructed in many ways and may use a variety of sensors to measure the temperature. The sensor can comprise one or more of a bimetallic mechanical sensor, a bimetallic electrical sensor, a thermistor, a semiconductor device, and a thermocouple.

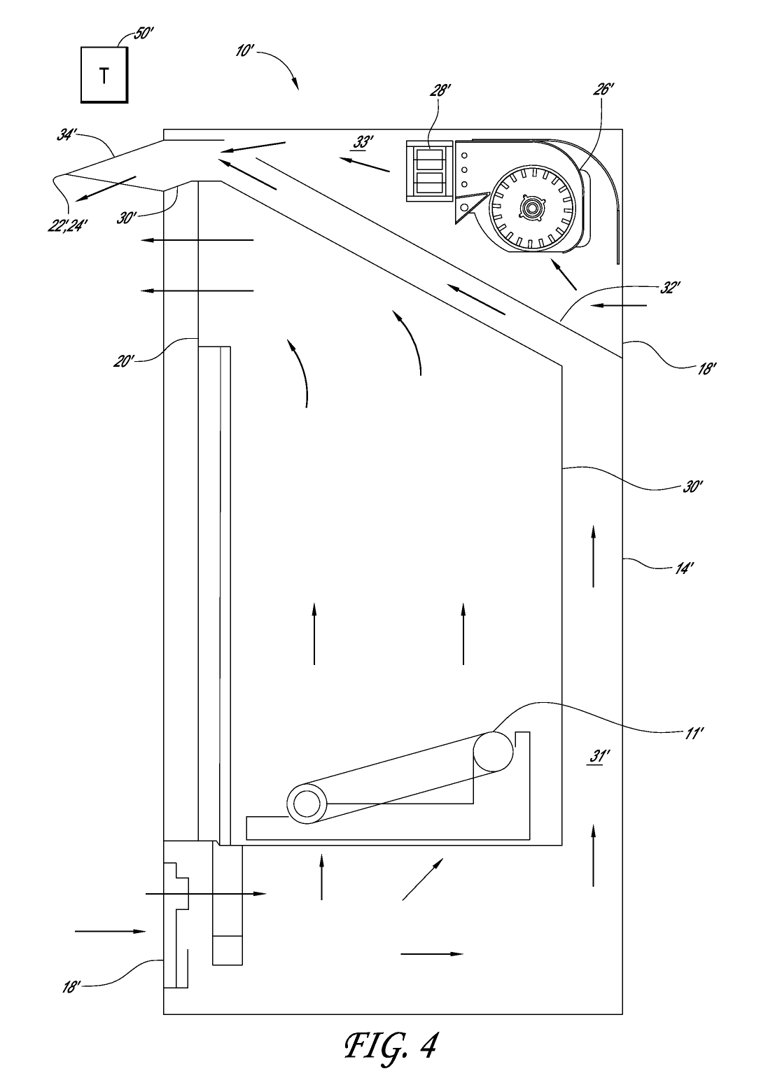

FIG. 4 illustrates another embodiment of a heating device 10′. Numerical reference to components is the same as previously described, except that a prime symbol (′) has been added to the reference. Where such references occur, it is to be understood that the components are the same or substantially similar to previously-described components. The heater 10′ of FIG. 4 shows certain variations to the air flow system discussed above with respect to FIG. 3 in addition to being a different type and/or style of heater. It should be understood that the illustrated heater includes each of the features designated by the numbers used herein. However, as emphasized repeatedly herein, these features need not be present in all embodiments.

The heater 10′ includes a fuel delivery system 11′, including a burner and a housing 14′. Similar to the heater 10 in FIG. 3, heater 10′ can be a vent free heater. The heater 10′ can be styled as a fireplace, including a grate and a log set to give the appearance of a natural wood burning fireplace.

The heater 10′ is shown having a firebox 30′ with at least part of the fuel delivery system 11′ on the floor of the firebox 30′. The heater 10′ includes two air inlets 18′, one located at the bottom front of the heater and one located at the top back of the heater. Air from the first inlet 18′ located at the bottom of the heater 10′ can be used to draw in air to be supplied to the fuel delivery system 11′, including the burner, and also to the first channel outside of and surrounding the firebox 30′. A first channel 31′ is positioned primarily between the firebox 30′ and the housing 14′. The second inlet 18′ located at the top of the heater directs air to the fan 26′ and electric heating element 28′ through a second channel 33′. A panel 32′ can separate all or a portion of the first channel 31′ and the second channel 33′. As shown, the first channel 31′ and second channel 33′ combine near the hood 34 and have a combined exit through outlet 22′, 24′. In some embodiments, the outlets 22′ and 24′ can be maintained separately. Other configurations are also possible, as will be understood by one of skill in the art.

A heating apparatus can include a housing, a gas heating unit positioned within the housing, and an electric heating element positioned within the housing. The housing can have at least one air inlet, at least one air outlet, and a firebox. The gas heating unit can include a pressure regulator configured to regulate a flow of fuel, a burner configured such that combustion occurs within the firebox, a nozzle positioned to direct the flow of fuel to the burner; and a control valve configured to control the amount of fuel in the flow of fuel. The heating apparatus may also include a fan positioned within the housing configured to draw air into the housing through the at least one air inlet.

In some embodiments, the heating apparatus can comprise a first air channel outside of and surrounding at least part of the firebox. The first air channel can be configured such that air within the first air channel is heated by heat from the firebox. A second air channel can be configured such that air within the second air channel is heated by heat from the electric heating element.

In some embodiments, the second channel is insulated from the first channel such that there is no heat transfer between the first channel and the second channel The second channel can also be positioned within the housing substantially parallel with the first channel.

The at least one air inlet can comprise a first inlet and a second inlet. The first inlet can draw air into the first channel and the second inlet can draw air into the second channel and not into the first channel The first outlet can exhaust air from the firebox and the second outlet can exhaust air from either or both the first air channel and the second channel.

In some embodiments, the at least one air inlet is in fluid communication with the first air channel, the second air channel, and the firebox. The at least one air outlet can include a first outlet, a second outlet, and a third outlet, the first outlet configured to exhaust air from the firebox, the second outlet configured to exhaust air from the first air channel and the third outlet configured to exhaust air from the second channel.

In some embodiments, the second channel comprises an angled baffle configured to direct air to the fan and electric heating element. In some embodiments, the electric heating element is positioned outside of the firebox. In some embodiments, the electric heating element is positioned directly adjacent a fan outlet of the fan.

A heating apparatus can comprise a housing having at least one air inlet, at least one air outlet, a firebox, a first air channel outside of and surrounding at least part of the firebox, and a second air channel. The heating apparatus may also include a gas heating unit positioned within the housing and having a pressure regulator configured to regulate a flow of fuel, a burner positioned within the firebox and configured such that combustion occurs within the firebox, a nozzle configured to direct the flow of fuel to the burner, and a control valve positioned in fluid communication with and between the pressure regulator and the nozzle and configured to control the amount of fuel in the flow of fuel. In some embodiments, an electric heating element can be positioned within the second air channel and configured such that air within the second air channel is heated by heat from the electric heating element. A fan may also be used, positioned within the housing and configured to draw air into the housing through the at least one air inlet.

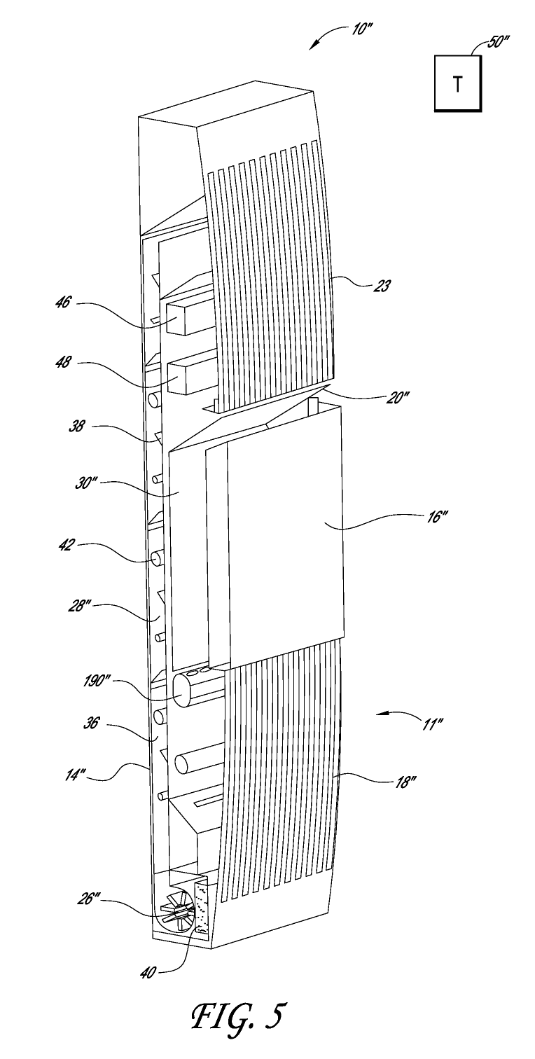

FIGS. 5-7 illustrate another embodiment of a heating device 10″. Numerical reference to components is the same as previously described, except that prime symbols (″) have been added to the reference. Where such references occur, it is to be understood that the components are the same or substantially similar to previously-described components. The hybrid heater 10″ of FIG. 5 shows certain variations to the air flow and heating systems, among other things. It should be understood that the illustrated heater includes each of the features designated by the numbers used herein. However, as emphasized repeatedly herein, these features need not be present in all embodiments.

The heater 10″ includes a fuel delivery system 11″, including a burner 190″ and a housing 14″. The fuel delivery system 11″ can be a single fuel or a dual fuel system, to use, for example, either natural gas or propane. As shown, the heater 10′ is a vent free heater and may be a portable unit or an installed unit. The heater 10″ is shown in cross-section to illustrate some of the internal components of the heater.

The heater 10″ has a firebox 30″ with a fuel delivery system 11″. The fuel delivery system 11″ can include various components as have been described, such as a burner 190″, a pressure regulator, a nozzle, a pilot or ODS, etc. The air inlet 18″ allows air to flow to the burner 190″ within the firebox 30″ to assist in combustion of the fuel. The heated exhaust air can then exit through the outlet 20″ to the heater's surroundings, such as a room environment. A single or double paned panel or window 16″ can be positioned in front of the firebox 30″ such that airflow is directed over and around the panel or window 16″ in a controlled manner and the combustion is confined within the firebox.

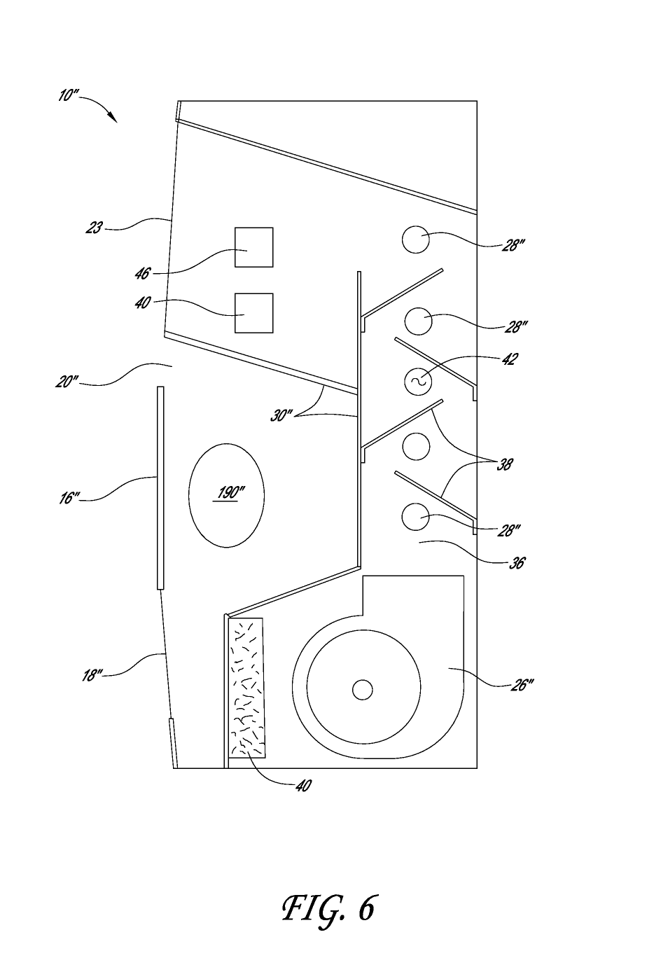

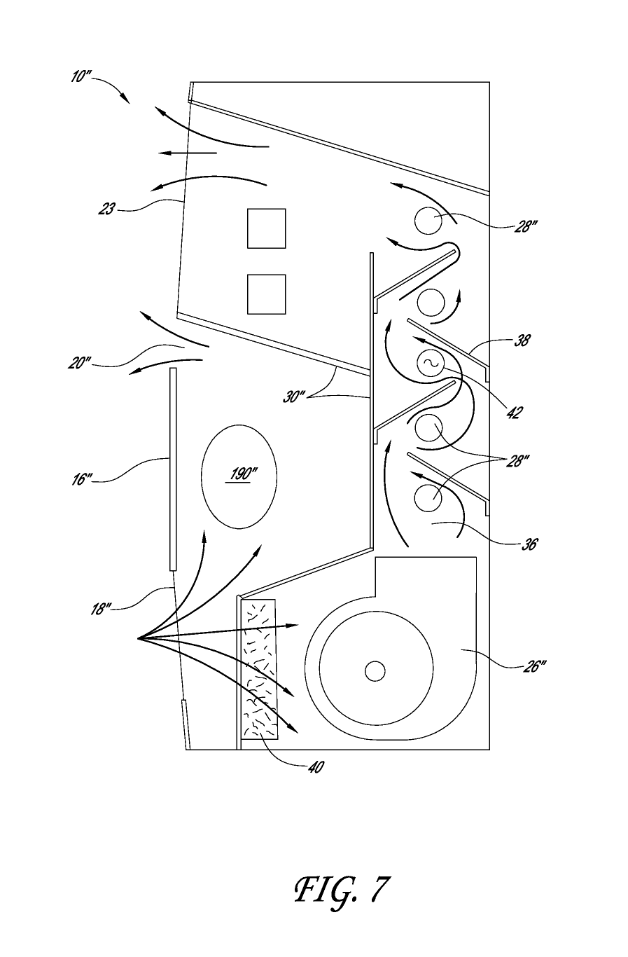

The heater 10″ includes an electric heating system which will be described with reference to FIGS. 5-7. FIGS. 6 and 7 show the heater of FIG. 5 in schematic to more simply illustrate some of the components and flow patterns within the heater 10″.

A fan 26″ can draw air through the inlet 18″ into a channel 36 positioned outside of and surrounding the firebox 30″. As discussed with respect to previous embodiments, air in the channel 36 surrounding the firebox 30″ can absorb heat from the firebox, and remove that heat to the outside environment.

Looking to FIG. 6, it can be seen that a number of baffles or deflectors 38 can be positioned within the channel 36. The baffles 38 can be made of many materials, one example being sheet metal that has been bent to the desired configuration. The baffles 38 can direct the air flow through the channel 36. The baffles 38 can also slow down the air flow from the fan 26″ and cause the air to absorb more heat then possible without the baffles 38.

The baffles can force more of the air flow to contact the firebox 30″ to absorb heat from the firebox with the air. The baffles 38 themselves may serve as heat sinks, similar to the fins on a standard heat sink. In particular, those baffles which are in contact with the firebox 30″ can draw heat from the firebox to transfer some of that heat to the air flowing through the channel 36.

In some embodiments, the baffles 38 can direct the air to flow in and around the heating elements 28″. The arrows in FIG. 7 show example air flow paths into the channel 36, around the heating elements 28″ and then out of the channel 36. The arrows also illustrate example air flow paths through the firebox 30″.

The fan 26″ can be a high power fan. For example, a typical 20K BTU gas heater may have a fan rated at 20-40 cfm (cubic foot per minute). The high power fan 26″ can be rated at 150 cfm. Thus the fan 26″ can move a large amount of air, to provide an increased amount of heating. In current gas heaters, the housing and firebox are large heat sinks that get very hot. The presence and use of a high power fan 26″ can greatly reduce the heat of the housing and firebox while also transferring a large amount of heat to the room environment.

All or part of the electric heating system can also be positioned within the channel 36. The electric heating system can use one or more of many different types of heating elements 28″ as have been described. The plurality of heating elements 28″ can preferably be quartz emitters as part of an infrared heater.

Preferably, the heater 10″ has a plurality of heating elements 28″ positioned within the channel 36. The plurality of heating elements 28″ can be positioned in series and/or in parallel within the channel As shown, the heating elements 28″ are positioned in series so that the air flow can continue to absorb heat throughout its flow through the channel. Thus, a large air flow has many opportunities to absorb heat increasing the heat to be disbursed to the environment.

The plurality of heating elements 28″ and the baffles 38 can be positioned so that at least one heating element is positioned next to each baffle. In some embodiments, other devices, such as a UV lamp 42 (described in detail below) can also be positioned within the channel. As shown, a first heating element 28″ is positioned next to the fan 26″ followed by a first baffle 38. Then there is a second heating element 28 followed by a second baffle 38. A UV lamp is positioned between the second and third baffles 38. Finally, a fourth baffle is positioned between third and fourth heating elements 28. The baffles 38 can direct the air to flow around the heating elements 28 and/or UV lamp. In some embodiments, the UV lamp or another device positioned within the channel 36 can also provide some heating and may serve as a heating element.

Though the firebox 30″ has been described as allowing for heat transfer to air in the channel 36, it should also be understood that the firebox can be adiabatic, and/or adiabatic panels can be employed to maintain the electric heating system and the heating from the fuel delivery system completely separate, at least when considered within the heater. Thus, the heat transfer in the channel 36 would occur only with the heating elements and not with the firebox.

It will also be understood that the illustrated heater 10″ could provide heating within the channel 36 in ways besides with electric heating elements. For example, heated water or heated gas could be pumped into pipes that run within the channel 36. This heat could then be transferred to the air flowing through the channel 36.

The heater 10″ can also function as an air purification system. A filter 40 is shown positioned in front of the fan 26″ in FIGS. 5-7. The filter 40 can filter out and clean the air. The filter can also ensure that debris does not enter the channel 36 or come into contact with the heat elements 28. Thus, air drawn into the channel 36 can first flow through the filter 40 before entering the fan 26″ and/or the channel 36.

The air purification system can also include other components, such as UV lamps 42, ozone generating devices 44, and negative ion generating devices 46. The UV lamp 42 can sterilize the air as it flows through the channel 36. When the users leave the room they can open the ozone generating device 44 and the negative ion generating device 46 to disinfect the entire room. In some embodiments, the air purification system includes only the filter. In some embodiments, one or more of the ozone generating device, negative ion generating device, and UV lamp are not included as part of the air purification system.

The hybrid configuration of a combination gas and electric heater can provide many benefits to a user. For example, a 20K BTU gas heater unit can be replaced with a hybrid heater unit having a 10K BTU gas unit and a 5K BTU equivalent electric unit. A 1500 W electric heater system can generate the equivalent of approximately 4800-5K BTU. In some geographic regions, in particular those with high humidity, gas vent free heaters can generate large moisture content, as well as, a small amount of CO₂, and CO which are all byproducts of the combustion process and are passed to the room environment. In dry climates, this water vapor can be desirable, but in wet climates it can create additional problems such as mold. The hybrid heater can beneficially reduce moisture generation by as much as 30% for the same BTU or power output. This can be combined with the air purification and/or air filtration features which may be included on some units that may additionally reduce mold and germs, especially those that are airborne.

The heater 10″ can include one or more programs or settings. For example, the heater can be programmed to turn on the electric heater first and then the gas heater to get the heater or the room to the desired temperature. The gas heater can then turn off. The electric heater can stay on to maintain a desired temperature. If or when needed, the gas heater can cycle back on to raise the temperature back to the desired temperature. Thus, the electric heater stays on while the gas heater cycles on and off as needed, such as in response to feedback from a sensor 50″. Other configurations are also possible, as will be understood by one of skill in the art.

The heater 10″ can be connected to a control or feedback system 50″ that provides feedback to the heater 10″. The feedback system 50″ can be used to regulate the temperature and to control the two different heat sources. For example, the electric heating elements 28″ can remain on to provide a steady supply of heat. When the feedback system 50″ detects a decrease in temperature the fuel delivery system 11″ can turn on to provide the extra heat needed. This may occur, for example, after a door to the outside has been opened. Thus, the electric heating elements 28″ and the fuel delivery device 11″ can be used with the feedback system to regulate the temperature or maintain a fairly steady temperature, turning on one system only when needed to boost the heat output, provide supplemental heated air, or adjusting heat output in real time to maintain the desired temperature. The feedback system 50″ can comprise a thermostat that may be constructed in many ways as previously discussed.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A heating apparatus comprising
a housing having:
at least one air inlet;
at least one air outlet; and
a firebox;
a gas heating unit positioned within the housing and comprising:
a pressure regulator configured to regulate a flow of fuel;
a burner positioned within the firebox and configured such that combustion occurs within the firebox;
a nozzle configured to direct the flow of fuel to the burner; and
a control valve positioned in fluid communication with and between
the pressure regulator and the nozzle and configured to control the amount of fuel in the flow of fuel; and
an electric heating element positioned within the housing; and
a feedback system configured to monitor a temperature and control the utilization of both the gas heating unit and the electric heating element to provide desired heating.

2. The heating apparatus of claim 1, wherein the feedback system comprises a thermostat.

3. The heating apparatus of claim 2, wherein the thermostat comprises a thermocouple.

4. The heating apparatus of claim 1, wherein the temperature comprises at least one of a room temperature, a heating apparatus output temperature, and a heating apparatus temperature.

5. The heating apparatus of claim 1, wherein the housing further comprises a first air channel outside of and surrounding at least part of the firebox.

6. The heating apparatus of claim 5, wherein the electric heating element is positioned within the first air channel such that air within the first air channel is heated by heat from the electric heating element.

7. The heating apparatus of claim 6, wherein the first air channel is configured such that air within the first air channel is also heated by heat from the firebox.

8. The heating apparatus of claim 1, wherein the electric heating element comprises a plurality of electric heating elements positioned within a first air channel.

9. The heating apparatus of claim 8, further comprising a plurality of baffles positioned within the first air channel, wherein the plurality of electric heating elements are dispersed among the plurality of baffles.

10. The heating apparatus of claim 9, further comprising a fan configured to direct air from the at least one air inlet through the first air channel, around the plurality of electric heating elements and plurality of baffles, and out the at least one air outlet.

11. The heating apparatus of claim 6, further comprising a second air channel positioned between the firebox and the first air channel and configured such that air within the second air channel is heated by heat from the firebox.

12. The heating apparatus of claim 11, wherein the second channel is insulated from the first channel such that there is no heat transfer between the first channel and the second channel.

13. The heating apparatus of claim 11, wherein the at least one air inlet comprises a first inlet and a second inlet, the first inlet configured to draw air into the first channel and the second inlet configured to draw air into the second channel and not into the first channel.

14. The heating apparatus of claim 13, wherein the at least one air outlet comprises a first outlet and a second outlet, the first outlet configured to exhaust air from the firebox and the second outlet configured to exhaust air from both the first air channel and the second channel.

15. The heating apparatus of claim 11, wherein the at least one air outlet comprises a first outlet and a second outlet, the first outlet configured to exhaust air from the firebox and the second outlet configured to exhaust air from either or both of the first air channel and the second channel

16. The heating apparatus of claim 5, wherein the at least one air inlet is in fluid communication with the first air channel and the firebox.

17. The heating apparatus of claim 11, wherein the second channel comprises an angled baffle configured to direct air to a fan and the electric heating element.

18. The heating apparatus of claim 1, further comprising a fan positioned within the housing and configured to draw air into the housing through the at least one air inlet.

19. A heating apparatus comprising
a housing having:
at least one air inlet;
at least one air outlet;
a firebox;
an air channel outside of and surrounding at least part of the firebox;
a gas heating unit positioned within the housing and comprising:
a pressure regulator configured to regulate a flow of fuel;
a burner positioned within the firebox and configured such that combustion occurs within the firebox; and
a nozzle configured to direct the flow of fuel to the burner;
an electric heating element positioned within the air channel and configured such that air within the air channel is heated by heat from the electric heating element; and
a thermostat configured to control both the gas heating unit and the electric heating element.

20. The heating apparatus of claim 19, wherein the air channel is configured such that air within the first air channel is also heated by heat from the firebox.

21. The heating apparatus of claim 19, further comprising a fan configured to direct air flow through the air channel.

22. The heating apparatus of claim 21, wherein the electric heating element comprises a plurality of electric heating elements.

23. The heating apparatus of claim 22, further comprising a plurality of baffles positioned within the air channel.

24. The heating apparatus of claim 23, wherein the plurality of electric heating elements are positioned in series within the air channel such that the plurality of baffles direct air flow to each individual heating element.

25. The heating apparatus of claim 19, wherein the gas heating unit comprises at least one of a vent free heater, a direct vent heater, a plaque heater, a stove, a blue flame generating heater, a yellow flame generating heater, and a dual-fuel heater.

26. The heating apparatus of claim 19, wherein the thermostat is configured to cycle the gas heating unit on and off as needed while utilizing the electric heating element for primary heating.

27. A heating apparatus comprising
a housing having:
at least one air inlet;
at least one air outlet;
a firebox;
an air channel outside of and surrounding at least part of the firebox;
a gas heating unit positioned within the housing and comprising:
a pressure regulator configured to regulate a flow of fuel;
a burner positioned within the firebox and configured such that combustion occurs within the firebox; and
a nozzle configured to direct the flow of fuel to the burner; and
a plurality of electric heating elements positioned within the air channel and configured such that air within the air channel is heated by heat from the plurality of electric heating elements.

28. The heating apparatus of claim 27, further comprising a thermostat configured to control both the gas heating unit and the plurality of electric heating elements.

29. The heating apparatus of claim 27, wherein the air channel is configured such that air within the first air channel is also heated by heat from the firebox.

30. The heating apparatus of claim 27, further comprising a fan configured to direct air flow through the air channel.

31. The heating apparatus of claim 30, further comprising a plurality of baffles positioned within the air channel.

32. The heating apparatus of claim 31, wherein the plurality of electric heating elements are positioned in series within the air channel such that the plurality of baffles direct air flow to each individual heating element.

33. A hybrid heater control method comprising:
providing heat with an electric heating element;
sensing a decrease in temperature from a setpoint temperature;
activating a gas heating unit to combust gas at a burner;
providing heat with both the gas heating unit and the electric heating element;
sensing a return in temperature to the setpoint temperature;
deactivating the gas heating unit; and
continuing to provide heat with the electric heating element.

34. The method of claim 33, wherein activating the gas heating unit comprises igniting a first gas flow at a pilot light or oxygen depletion sensor.

35. The method of claim 34, wherein activating the gas heating unit further comprises igniting a second gas flow at the burner.
